(19) United States
(12) Patent Application Publication
(10) Pub. No.: US 2005/0080810 A1
(43) Pub. Date: Apr. 14, 2005

(54) Data management apparatus

(76) Inventor: Yohei Matsuura, Tokyo (JP)

Correspondence Address: BIRCH STEWART KOLASCH & BIRCH, PO BOX 747, FALLS CHURCH, VA, 22040-0747, US

(21) Appl. No.: 10/910,304

(22) Filed: Aug. 4, 2004

(30) Foreign Application Priority Data
Oct. 10, 2003 (JP) 2003-345324

(51) Int. Cl. G06F 17/00

(52) U.S. Cl. 707/102

(57) ABSTRACT

The present invention aims to improve the performance, reliability, and availability in a distributed file system environment. A load observing unit of a distributed file system management server observes load status of each disk, and when the load of a specific disk exceeds a predetermined level, a data controlling unit moves data stored in that disk to another disk, and updates directory information of a directory information database by reflecting this data migration. When a client makes an inquiry for the directory information, a directory notifying unit sends the updated directory information to that client, and a cache of a directory information database of the client side is updated.

### BACKGROUND OF THE INVENTION

1. Field of the Invention

The present invention relates to a distributed file system where data are distributed in disks connected to a storage network.

2. Description of the Related Art

FIG. 30 shows a conventional distributed file system management apparatus and a distributed file management system disclosed in, for example, JP2000-207370. In the figure, a reference numeral 102 shows a computer site A, 103 shows a computer site B, both of which are respectively connected to a network 101. The sites have a server computer A 105 and a server computer B 106, which are connected to the network 101 via a sub-network 131 and a sub-network 132, respectively. The server computer includes a storage device 115 storing a partial file 126a, a storage device 120 storing a partial file 126b, network interfaces 113 and 118, partial file managing units 111 and 116 which control reading or writing partial files, distributed file managing units 112 and 117, and status managing units 114 and 119.

Next, the operation will be explained. The status managing units 114 and 119 observe load of the server computers of each site, and determines a server to which the partial file is distributed based on the load information. According to this determination, the partial file managing unit and the distributed file managing unit manage files and avoids concentration of access load from a group of clients.

The related art of this invention is Japanese unexamined patent publication JP2000-207370.

In the above system, the partial files and the managing unit exist on the same server, and there is a problem that when a fault happens on the server, it becomes impossible for the client to access the partial files which the server holds.

The present invention is provided mainly to solve the above-mentioned problem and aims mainly to improve the performance, reliability and availability of the system by separating the disks from the management server and connecting them via the storage network.

### SUMMARY OF THE INVENTION

According to the present invention, a data management apparatus connected to a plurality of data storage devices and a plurality of data obtainment devices being capable to obtain data by accessing any one of the data storage devices, the data management apparatus includes:
a directory information database storing directory information showing which data is stored in which of the data storage devices;
a load observing unit observing load status of the plurality of data storage devices;
a data controlling unit analyzing an observation result by the load observing unit, when the load status of a specific data storage device matches a predetermined condition, moving at least a part of data stored in the specific data storage device to any one of the data storage devices, and updating the directory information by reflecting the data migration; and
a directory notifying unit, when an inquiry of directory information related to the data which has been moved by the data controlling unit is received from a specific data obtainment device, sending at least the directory information related to the moved data among the directory information after updating to the specific data obtainment device.

The data management apparatus is connected to a plurality of data obtainment devices having a cache of directory information; and the directory notifying unit, when an inquiry of directory information related to the data which has been moved by the data controlling unit is received from a specific data obtainment device, sends at least the directory information related to the moved data among the directory information after updating to the specific data obtainment device so as to update the cache of directory information held by the specific data obtainment device.

The data controlling unit analyzes the observation result of the load observing unit, when a load of a specific data storage device exceeds a predetermined level, moves at least a part of data stored in the specific storage device to any one of the data storage devices, and updates the directory information by reflecting the data migration.

The load observing unit observes the load status of each data stored in each of the data storage devices, and the data controlling unit analyzes the observation result of the load observing unit, when the load of the specific data exceeds a predetermined level, divides the specific data into an arbitrary number of pieces, moves at least a part of divided data which has been divided from the specific data to any one of the data storage devices, and updates the directory information by reflecting the data migration.

The load observing unit observes the load status of each data area of the data stored in each of the data storage devices, and the data controlling unit analyzes the observation result of the load observing unit, when the load of a specific data area exceeds a predetermined level, divides the specific data area into an arbitrary number of pieces, moves at least a part of divided data divided from the specific data area to any one of the data storage devices, and updates the directory information by reflecting the data migration.

The load observing unit observes the load status of each data stored in each of the data storage devices, and the data controlling unit analyzes the observation result of the load observing unit, when the load of a plurality pieces of mutually consecutive data is under a predetermined level, unites the plurality pieces of mutually consecutive data into united data, moves the united data to any one of the data storage devices, and updates the directory information by reflecting the data migration.

The directory information database stores service level information for each data showing service level of each of the data stored in each of the data storage devices, and the data controlling unit, when the load of a plurality pieces of data exceeds a predetermined level, divides each of the plurality pieces of data into an arbitrary number of pieces, by referring to the service level information for each data stored in the directory information database, determines an order to move the plurality pieces of data based on the service level of each data, moves divided data of each of the plurality pieces of data according to the order determined, and updates the directory information by reflecting each data migration.

The data controlling unit selects a data storage device for a destination of data migration from the plurality of data storage devices based on characteristics of each of the plurality of data storage devices and moves data to the data storage device selected.

The data controlling unit selects a data storage device for a destination of data migration from the plurality of data storage devices based on spare capacity of each of the plurality of data storage devices and moves data to the data storage device selected.

The directory information database stores service level information for each obtainment device showing service level set for each of the plurality of data obtainment devices, and the data controlling unit refers to the service level information for each obtainment device stored in the directory information database, based on the service level set for a specific data obtainment device, selects a data storage device for a destination of data migration from the plurality of data storage devices, and moves data to the data storage device selected.

The data data controlling unit, selects a data storage device for a destination of the data migration from the plurality of data storage devices based on characteristics and spare capacity of each of the plurality of data storage device, and moves data to the data storage device selected.

The data controlling unit, when a service level of specific data is under a predetermined level, generates copy data of the specific data, moves the copy data to a data storage device in which a service level of the copy data generated exceeds the predetermined level, and updates the directory information by reflecting the data migration.

The data controlling unit sometimes generates a plurality of pieces of copy data of specific data, and makes service levels of the plurality of pieces of copy data different by moving the plurality of pieces of copy data to different data storage devices, and the directory notifying unit, upon receiving an inquiry of the directory information related to original data of the copy data as well as a notice of the service level requested by a specific data obtainment device from the specific data obtainment device, selects one of the plurality of pieces of copy data which matches the service level requested by the specific data obtainment device, and sends at least directory information related to the one of the plurality of pieces of copy data selected to the specific data obtainment device.

The data controlling unit, upon receiving a notice showing a service level of specific data does not match a service level required by a specific data obtainment device from the specific data obtainment device, generates copy data of the specific data, moves the copy data generated to a data storage device in which the service level requested by the specific data obtainment device can be obtained, and updates the directory information by reflecting the data migration.

The data controlling unit sometimes generates a plurality of pieces of copy data of specific data, and makes service levels of the plurality of pieces of copy data different by moving the plurality of pieces of copy data to different data storage devices, and the directory notifying unit, after the data controlling unit performs data migration of the plurality of pieces of copy data and updates the directory information, selects one of the plurality of pieces of copy data which matches a service level requested by a specific data obtainment device, and sends the directory information related to the one of the plurality of pieces of copy data to the specific data obtainment device.

The load observing unit observes load status of each data stored in each of the plurality of data storage devices, and the data controlling unit analyzes an observation result, when a load of specific data exceeds a predetermined level, divides at least a part of the specific data into an arbitrary number of pieces, moves at least a part of divided data which has been divided from the specific data to any one of the plurality of data storage devices, as a result of the data migration of the divided data, when reliability of a data storage device which is a destination of the divided data migration is under reliability of a data storage device which has originally stored the specific data, generates copy data of the divided data moved, and moves the copy data generated to another one of the plurality of data storage devices.

The data controlling unit, as a result of the data migration of the copy data, when reliability of a data storage device which is a destination of the copy data migration is under reliability of a data storage device which has originally stored the divided data, generates new copy data of the copy data moved, and moves the new copy data generated to another one of the plurality of data storage devices.

The load observing unit observes load status of each data stored in each of the plurality of data storage devices, and the data controlling unit analyzes an observation result, when a load of specific data exceeds a predetermined level, divides at least a part of the specific data into an arbitrary number of pieces, moves at least a part of divided data which has been divided from the specific data to any one of the plurality of data storage devices, as a result of data migration of the divided data, when reliability of a data storage device which is a destination of the divided data migration exceeds reliability of a data storage device which has originally stored the specific data and also when copy data of the divided data moved is stored in another one of the plurality of data storage devices, deletes the copy data stored in the another one of the plurality of data storage devices.

The data management apparatus is capable to communicate with another data management apparatus having directory information, and the data controlling unit, when updating the directory information of the data management apparatus, updates the directory information of the another data management apparatus.

The load observing unit notifies the another data management apparatus of the observation result of the load status of each of the plurality of data storage devices.

The data management apparatus sets a common directory information database which can be shared with another data management apparatus on a common network to be shared with the another data management apparatus, and the data controlling unit, when performing data migration of any data, updates common directory information stored in the common directory information database.

The data management apparatus manages specific directory subtree information among directory subtree information included in the common directory information database, and the data management apparatus, upon receiving an inquiry for the directory information related to specific data from a specific data obtainment device, when the specific data for which the inquiry has been made is not included in the specific directory subtree information which is managed by the data management apparatus itself, transfers the inquiry from the specific data obtainment device to another one of the data management apparatus, makes the another one of the data management apparatus send the directory information related to the specific data for which the inquiry has been made to the specific data obtainment device.

The data management apparatus sends at least a part of the directory subtree information which is managed by the data management apparatus itself to any one of the plurality of data obtainment devices and makes the data obtainment device to which at least a part of the directory subtree information is sent manage at least the part of the directory subtree information which is managed by the data management apparatus itself.

The data management apparatus, when at least a part of the directory subtree information which is supposed to be managed by the data management apparatus is managed by one of the plurality of data obtainment devices, and when the directory subtree information managed by the one of the plurality of data obtainment devices needs to be returned, receives the directory subtree information managed by the one of the plurality of data obtainment devices from the one of the plurality of data obtainment devices, and manages again the directory subtree information received.

The data management apparatus is connected to a storage network which connects the plurality of data storage devices and the plurality of data obtainment devices, and the data management apparatus communicates with the plurality of data storage devices and the plurality of data obtainment devices via the storage network.

The data management apparatus is connected to the plurality of data obtainment devices via other network besides a storage network which connects the plurality of data storage devices and the plurality of data obtainment devices, and the data management apparatus communicates with the plurality of data obtainment devices via the other network.

The data management apparatus is connected to the plurality of data storage devices via other network besides a storage network which connects the plurality of data storage devices and the plurality of data obtainment devices, and the data management apparatus observes the load status of the plurality of data storage devices via the other network.

### BRIEF EXPLANATION OF THE DRAWINGS

A complete appreciation of the present invention and many of the attendant advantages thereof will be readily obtained as the same becomes better understood by reference to the following detailed description when considered in connection with the accompanying drawings, wherein:

FIG. 1 shows a configuration example of a distributed file system according to a first embodiment;

FIG. 2 shows an example of data division;

FIG. 3 is an example of a flowchart related to a data controlling unit according to a second embodiment;

FIG. 4 shows an example of combining data according to a fourth embodiment;

FIG. 5 is an example of a flowchart related to a data controlling unit according to a fourth embodiment;

FIG. 6 shows an example of a directory information database according to a fifth embodiment;

FIG. 7 shows an example of service level information according to the fifth embodiment;

FIG. 8 is an example of a flowchart related to a data controlling unit according to the fifth embodiment;

FIG. 9 shows an example of a distributed file system management server according to a six embodiment;

FIG. 10 is an example of a flowchart related to a data controlling unit according to the six embodiment;

FIG. 11 shows an example of a distributed file system management server according to a seventh embodiment;

FIG. 12 shows an example of a directory information database according to an eighth embodiment;

FIG. 13 shows an example of service level information according to the eighth embodiment;

FIG. 14 shows an example of a distributed file system management server according to a ninth embodiment;

FIG. 15 is an example of a flowchart showing a detailed determination process of disk allocation;

FIG. 16 shows an example of a directory information database according to a tenth embodiment;

FIG. 17 is an example of a flowchart related to a data controlling unit according to the tenth embodiment;

FIG. 18 is an example of a flowchart related to a directory notifying unit according to an eleventh embodiment;

FIG. 19 is an example of a flowchart related to a data controlling unit according to a twelfth embodiment;

FIG. 20 is an example of a flowchart related to a data controlling unit according to a fourteenth embodiment;

FIG. 21 shows an example of a disk performance/capacity database according to the fourteenth embodiment;

FIG. 22 is an example of a flowchart related to a data controlling unit according to a fifteenth embodiment;

FIG. 23 shows a configuration example of a distributed file system according to a sixteenth embodiment;

FIG. 24 shows a configuration example of a distributed file system according to a seventeenth embodiment;

FIG. 25 shows examples of a distributed file system management server and a directory information database according to an eighteenth embodiment;

FIG. 26 shows examples of a distributed file system management server and a directory information database according to a nineteenth embodiment;

FIG. 27 is an example of a flowchart related to a client according to a twentieth embodiment;

FIG. 28 shows a configuration example of a distributed file system according to a twenty-first embodiment;

FIG. 29 shows a configuration example of a distributed file system according to a twenty-second embodiment; and

FIG. 30 shows the conventional distributed file system.

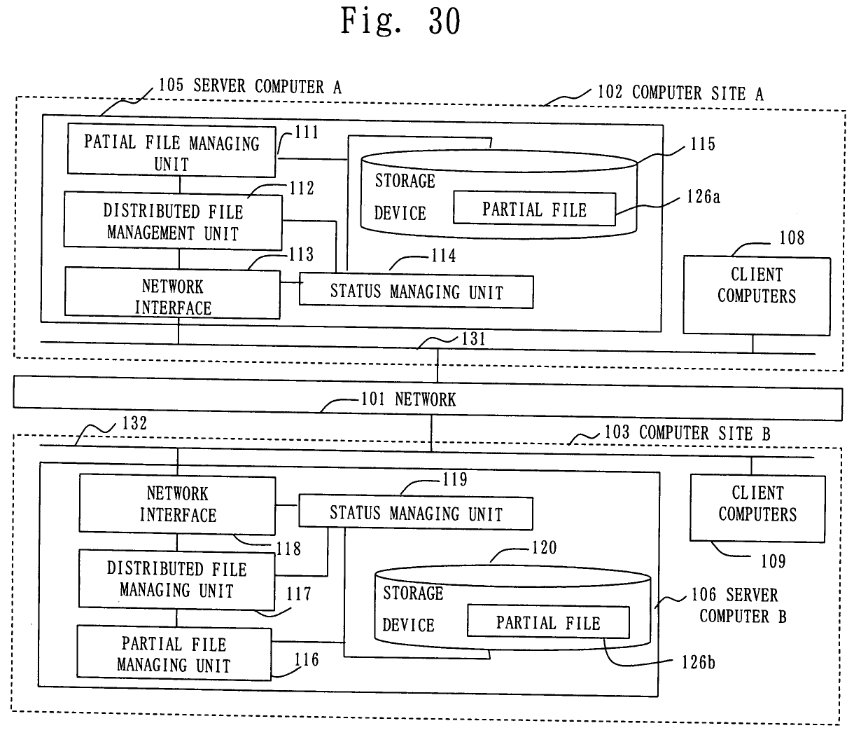

### DESCRIPTION OF THE PREFERRED EMBODIMENT

Embodiment 1.

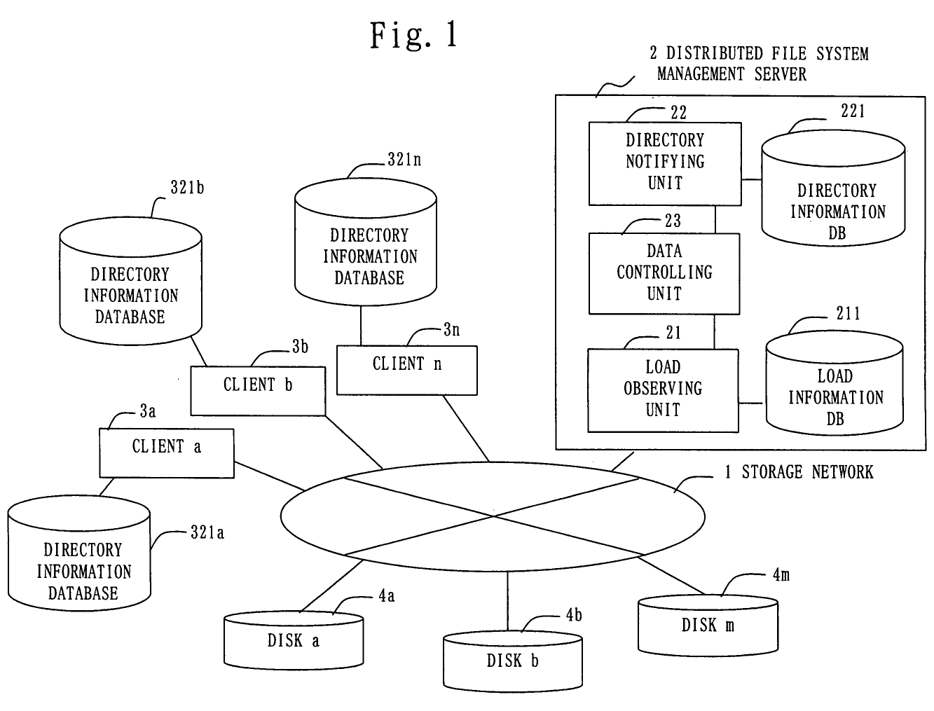

FIG. 1 shows a configuration example of a distributed file system according to a first embodiment. In the figure, a reference numeral 1 shows a storage network, 2 shows a distributed file system management server, 3a through 3n show a group of clients, 4a through 4m show a group of disks, which are connected to the storage network. Here, the distributed file system management server 2 corresponds to an example of a data management apparatus, the clients 3a through 3n correspond to an example of a data obtainment device, and the disks 4a through 4m correspond to an example of a data storage device.

In addition, in the distributed file system management server, a load observing unit 21 which observes the line load of the storage network and the access load of the disks, a load information database 211 which stores load information, a directory information database 221 which stores directory information showing what data is stored in which disk, a directory notifying unit 22 which notifies a location of data when a client makes an inquiry for certain data, and a data controlling unit 23 which transfers data on the disks. The client has caches 321a through 321n of the directory information database 221.

Here, the distributed file system management server 2 can be implemented by for example, a computer including a CPU such as a micro-processor, etc., storage means such as a semi-conductor memory, etc. and a magnetic disk, etc. and communication means, which are not illustrated. The storage means stores programs for implementing functions of each component included in the distributed file system management server 2, and the function of each component can be implemented by the CPU with reading these programs and controlling the operation of the distributed file system management server 2.

Next, the operation will be explained.

First, status of the load of the storage network 1 and the group of disks 4a through 4m are polled by the load observing unit 21, and the load information is periodically stored in the load information database 211. When the load of an arbitrary disk exceeds a predetermined level, the data controlling unit 23 moves data on the disk to another disk which has less load, and directory information of the directory information database 221 is updated by reflecting this data migration. Either all or a part of data within the disk of which the load exceeds can be moved to another disk. Further, the number of disks to which the data is moved can be either one or plural.

The clients 3a through 3n access the data using cached data of the directory information databases 321a through 321n, but it is impossible to normally access the data which has been moved by the data controlling unit, since there occurs inconsistency between the directory information database of the distributed file system management server 2 and the directory information database of the client. In this case, the client makes an inquiry to the directory notifying unit, the directory notifying unit sends the client the directory information related to at least the data for which the inquiry has been made, out of updated directory information, and the client obtains at least a part of the updated directory information.

As discussed above, in this embodiment, the distributed file system management server observes the status of the load of each disk, and when the load of a specific disk exceeds a predetermined level, moves the data of such disk to an appropriate location, updates the directory information by reflecting the data migration, and in a predefined case, notifies the client of the updated directory information, and updates the cache of client. By performing like this, even if the distributed file system management server stops the operation due to a failure, the client can access an appropriate disk to obtain desired data, which improves the reliability of the system.

Embodiment 2.

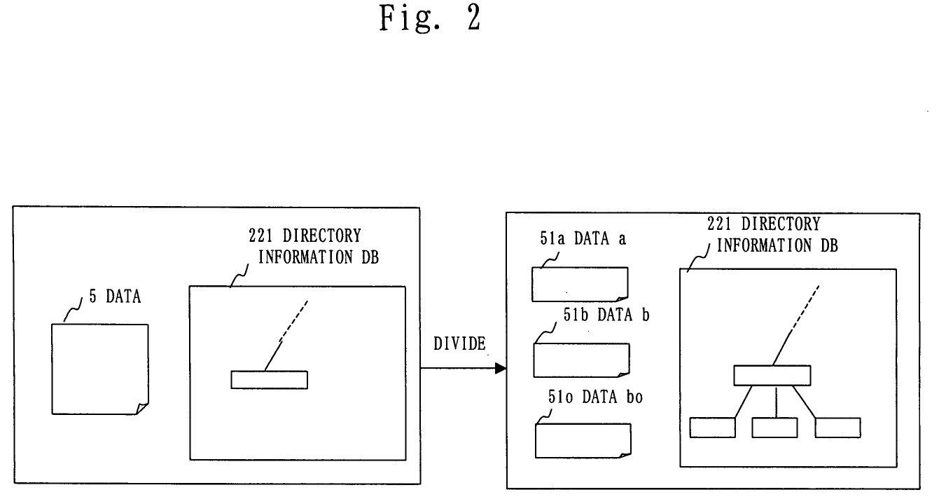

In the above first embodiment, the load is distributed by moving the data to an arbitrary disk. Next, another embodiment will be discussed in which availability will be increased by dividing and moving the data. FIG. 2 shows an example of data division in such a case. The system configuration is the same as the one of FIG. 1.

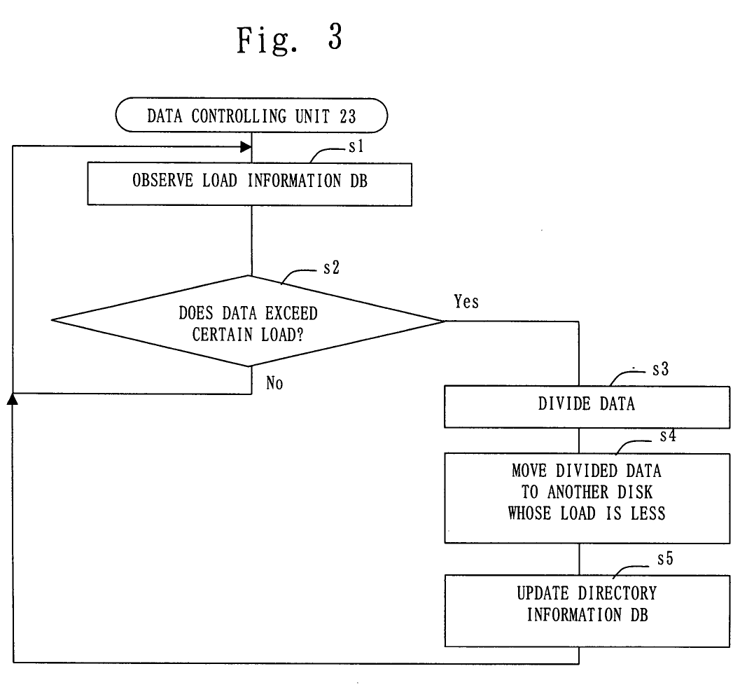

The operation will be explained in the following. FIG. 3 shows a flowchart related to the data controlling unit 23 of the distributed file system management server 2 in connection with the present embodiment. The data controlling unit 23 periodically observes the load information database 211 (s1). Here, the load observing unit 21 observes the load status of each data stored in each disk. Because of this, when a load of arbitrary data exceeds a certain level (s2), the data controlling unit 23 divides the data on the disk into a predetermined number of pieces (s3) (refer to FIG. 2). The divided data is moved to another disk which has less load (s4), by reflecting this data migration, the directory information of the directory information database 221 is updated (s5). Here, all pieces of the divided data can be moved to another disk, or a part of the divided data remains in the original disk and the other divided pieces of data can be moved to another disk. Further, plural pieces of the divided data can be moved to one disk, or plural pieces of the divided data can be respectively moved to different disks.

Then, as well as the first embodiment, when the client makes an inquiry for the directory information, the directory notifying unit 22 notifies of the directory information related to the divided data to update the cache of the client.

By the above operation, it is possible to distribute the access load which has been concentrated to a specific piece of data and thus improve the availability.

Embodiment 3.

In the second embodiment, the data is divided into the predetermined number of pieces. Next, another embodiment will be discussed in which the availability is improved by dividing and moving the data based on the access load for each data area. The system configuration and the flowchart are the same as the ones in FIGS. 1 and 3.

The operation will be explained in the following. At s3 of FIG. 3, in case of dividing the data, the division is mainly carried out in a data area to which the access load is concentrated on certain data. That is, in this embodiment, the load observing unit 21 observes the load status for each data area of the data stored in each disk, and accordingly, when the load of a specific data area exceeds a certain level, the data controlling unit 23 divides this data area into an arbitrary number of pieces. The operations at and after s4 are the same as the ones of the second embodiment, and the explanation will be omitted.

By the above operation, it is possible to flexibly distribute the access load which has been concentrated on one piece of data and thus improve the availability.

Embodiment 4.

The second and third embodiments relates to the data division. Next, another embodiment will be explained in which the availability is improved by uniting consecutive pieces of data when the access load of the data is decreased.

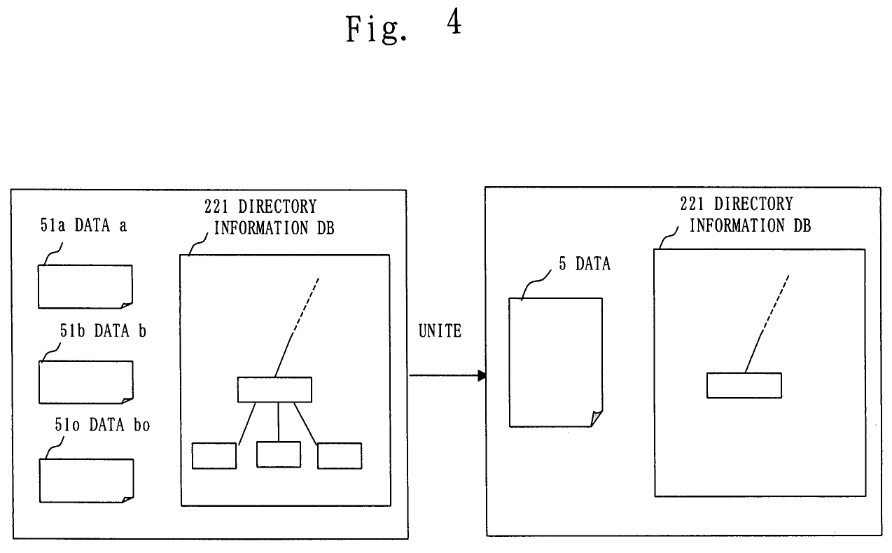

FIG. 4 shows an example of data union in such a case. The system configuration is the same as the one of FIG. 1.

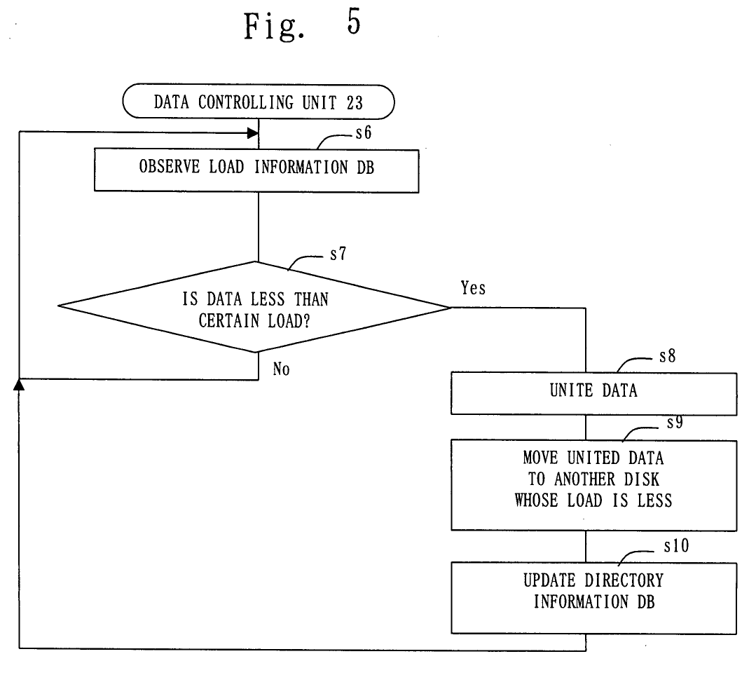

The operation will be explained in the following. FIG. 5 is a flowchart related to the data controlling unit 23 of the distributed file system management server 2 in connection with this embodiment. The data controlling unit periodically observes the load information database 211 (s6), and when the load of arbitrary consecutive plural pieces of data does not meet a certain level (s7), the data controlling unit unites the consecutive plural pieces of data on distributed disks (s8). The united data is moved to another disk which has less load (s9), and by reflecting the data migration of the united data, the directory information of the directory information database 221 is updated (s10).

By the above operation, it is possible to flexibly unite pieces of data of which the load is less and thus improve the availability.

Embodiment 5.

In the foregoing embodiments, the divided or moved data is allocated to the disk of which the load is less. Next, another embodiment will be explained in which the availability is improved by setting a service level for each data and allocating the data based on the service level.

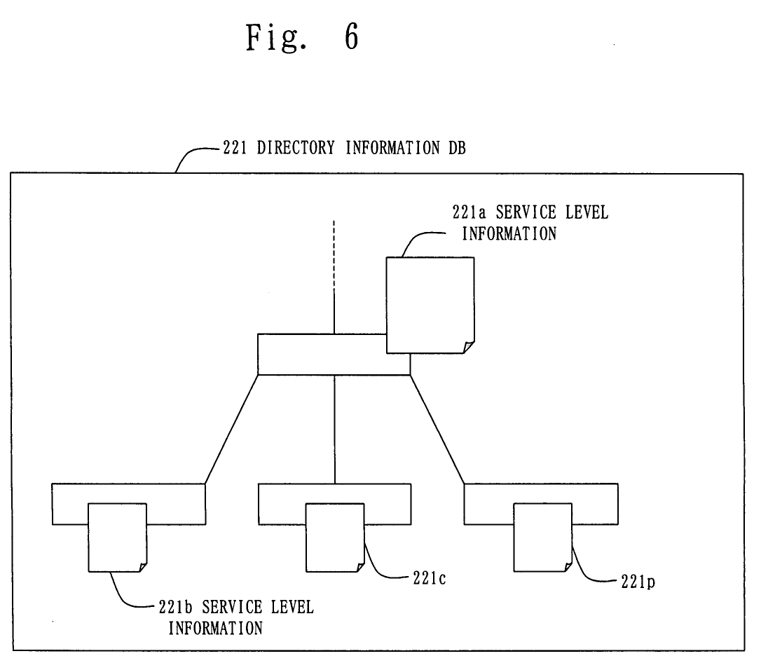

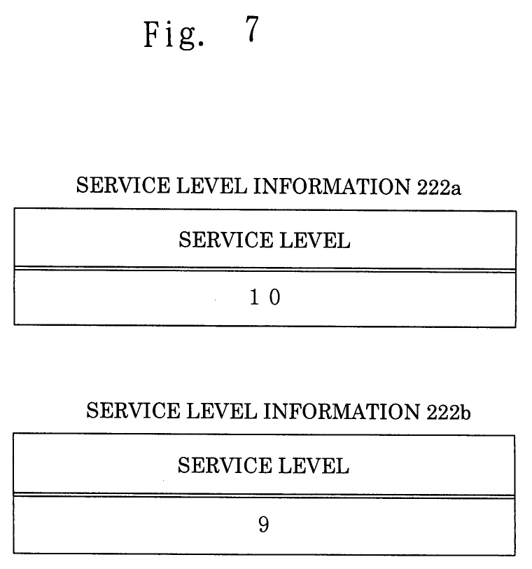

FIG. 6 shows a configuration example of the directory information database in which a service level is assigned to each data. In the figure, 221a through 221p show service level information added to the directory information. FIG. 7 shows an example of each service level information. Here, the service level of the data means a minimum rule which should be complied with on serving the client with data. For example, the service level of data is like “The reliability of data should be equal to or greater than 99.999%.”

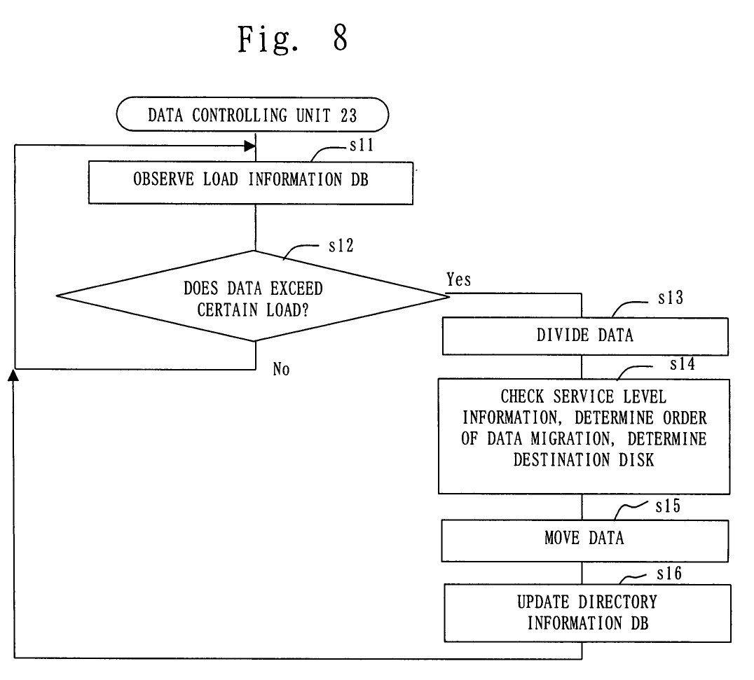

The operation will be explained in the following. FIG. 8 is a flowchart related to the data controlling unit 23 of the distributed file system management server 2 in connection with this embodiment. The data controlling unit periodically observes the load information database 211 (s11), and when the load of arbitrary data exceeds a certain level (s12), the data controlling unit divides the data by the procedures shown in the second or the third embodiment (s13). Here, in this embodiment, it is assumed that there are plural pieces of data of which the load exceeds a certain level, and the plural pieces of data are respectively divided. Then, the service level information written in the directory information database is referred to determine an order to carry out the data migration of the plural pieces of data, the order to carry out the data migration is determined, and disks are assigned, to which respective plural pieces of data are moved, according to the determined order (s14). Then, according to the determined order, the divided data are moved to the assigned disks (s15), and by reflecting each data migration the directory information of the directory information database 221 is updated (s16).

By the above operation, it is possible to flexibly distribute access based on the service level and thus improve the availability.

Embodiment 6.

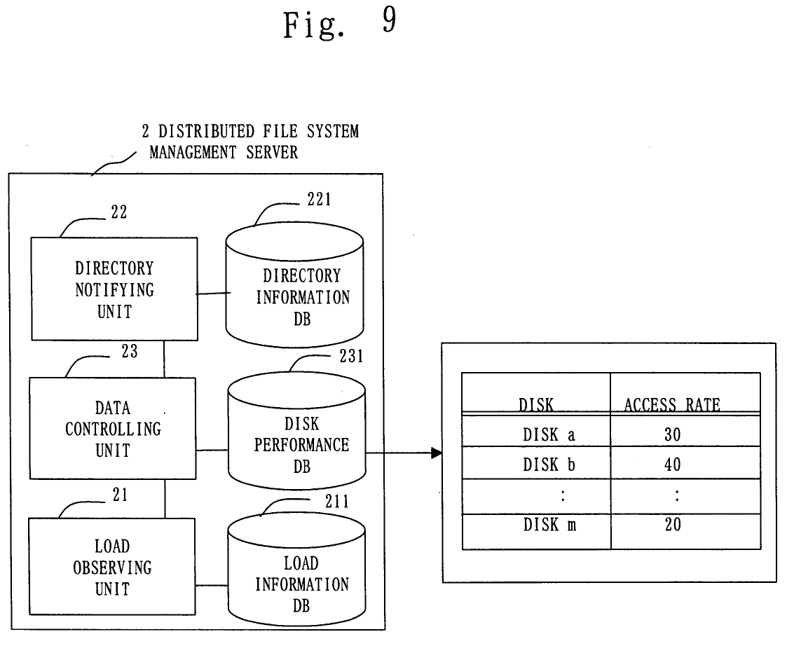

While in the first through third embodiments, when the load is concentrated to a specific disk, the data is moved to another disk whose load is less, in this embodiment, another case will be explained in which the data is moved based on other element besides the load, to be more concrete, characteristics of the disk. FIG. 9 shows the distributed file system management server 2 in connection with this embodiment. In the figure, the data controlling unit 23 includes a disk performance database 231. The disk performance database 231 stores disk performance information showing the performance (characteristics) of each disk. In the example of FIG. 9, an access rate is shown as the performance of each disk.

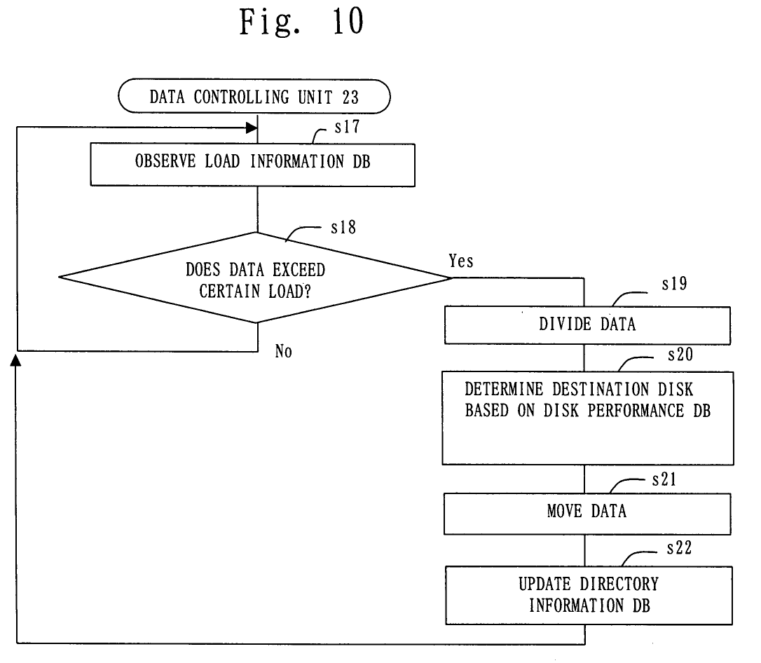

The operation will be explained in the following. FIG. 10 is a flowchart related to the data controlling unit 23 in the distributed file system management server in connection with this embodiment. The data controlling unit periodically observes the load information database 211 (s17), and when the load of an arbitrary piece of data exceeds a certain level (s18), the data controlling unit divides the data by the procedures shown in the second or the third embodiment (s19). Then, by referring to the disk performance database 231, a destination disk for the data is determined based on the characteristics of each disk (s20). For example, the disk which has the fastest access rate is determined as the designation disk. Then, the divided data is moved to the determined disk (s21), and by reflecting this data migration the directory information of the directory information database 221 is updated (s22).

By the above operation, it is possible to flexibly distribute the access load based on the performance of disks and thus improve the availability.

Embodiment 7.

While in the sixth embodiment, the destination disk is determined based on the performance of disk. Next, another embodiment will be shown in which the availability is improved by determining the destination disk based on remaining capacity of the disk.

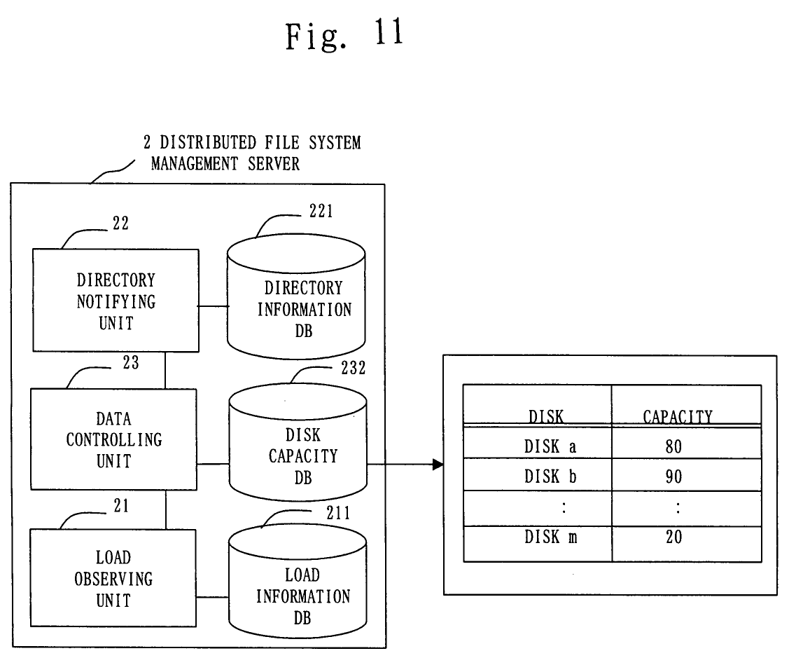

FIG. 11 shows the distributed file system management server 2 in connection with the present embodiment. In the figure, the data controlling unit 23 includes a disk capacity database 232. The disk capacity database 232 stores disk capacity information showing spare capacity of each disk.

The operation will be explained in the following. The operation of the data controlling unit 23 is the same as one shown in the flowchart of FIG. 10 except for the step s20. While in the sixth embodiment, the destination disk is determined based on the characteristics of disk by referring to the disk performance database (s20), in this embodiment, the destination disk is determined based on the spare capacity of disk by referring to the disk capacity database. For example, the disk which has the largest spare capacity is determined as the destination disk.

By the above operation, it is possible to distribute data with considering the capacity of disks and thus improve the availability.

Embodiment 8.

In this embodiment, another case will be explained in which the availability is improved by setting a service level for each client and by allocating the data based on this service level. Here, the service level for each client means the minimum performance the client has to achieve for the corresponding data (for example, a client “a” has to complete reading data A within one second, and so on).

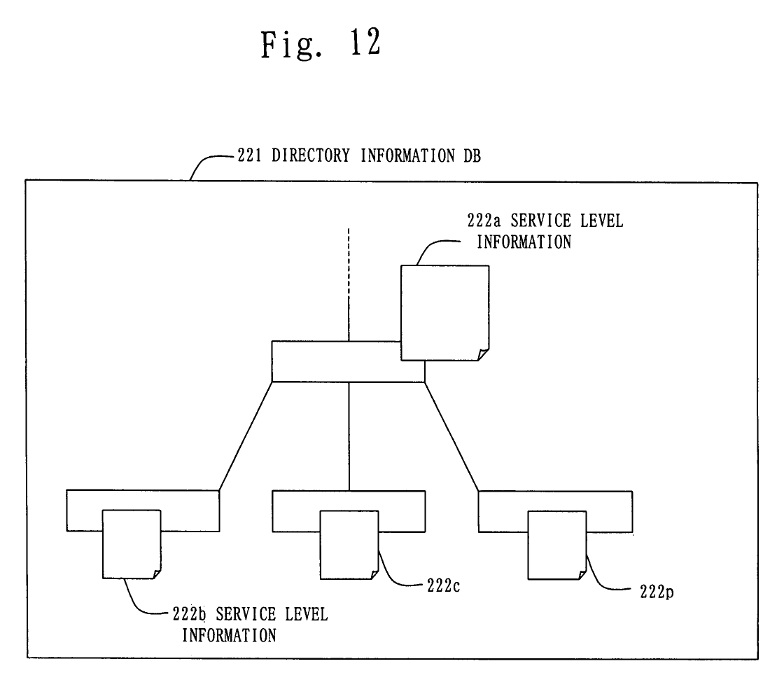

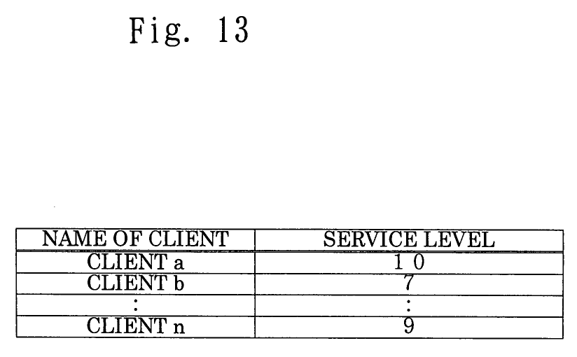

FIG. 12 shows a configuration example of the directory information database in which a service level is set for each client. In the figure, 222a through 222p show service level information added to the directory information. FIG. 13 shows an example of each service level information. In the figure, each service level information holds the service level for each client.

The operation will be explained in the following. The operation of the data controlling unit 23 is the same as one shown in the flowchart of FIG. 8. The data controlling unit periodically observes the load information database 211 (s11), and when the load of arbitrary data exceeds a certain level (s12), the data controlling unit divides the data by the procedures shown in the second or the third embodiment (s13). Then, by referring to the service level information written in the directory information database, based on service level information of a specific client a disk whose location is optimal to the client is determined as the destination disk considering from a view point of network (s14). The divided data is moved to the determined disk (s15), and the directory information database 221 is updated (s16).

As a concrete example of the operation of the above data controlling unit 23, for example, a case can be considered in which the service level information written in the directory information database stores information of network distance from clients and the data is allocated to the disk based on this information. For example, when “it is necessary to locate data A at a location within metric=2 from a client “a”” is set as the service level, the data controlling unit searches for disks located within metric=2 from the client “a” at s14 in the flowchart of FIG. 8 and determines an arbitrary one among the disks. In case of moving the data to the disk which has less load as shown in the first through third embodiments, a case may occur in which the data might be automatically allocated to the disk being far from a specific client. In the present embodiment, however, such a problem can be prevented since the destination disk is determined considering the service level of the client.

By the above operation, it is possible to locate the data at the optimal location for each client and thus improve the availability.

Embodiment 9.

In the above sixth embodiment, the destination disk is determined based on the performance of the disks, and in the seventh embodiment, the destination disk is determined based on the spare capacity of the disk. In the present embodiment, another case will be explained in which the availability is improved by determining the destination disk by combining these methods.

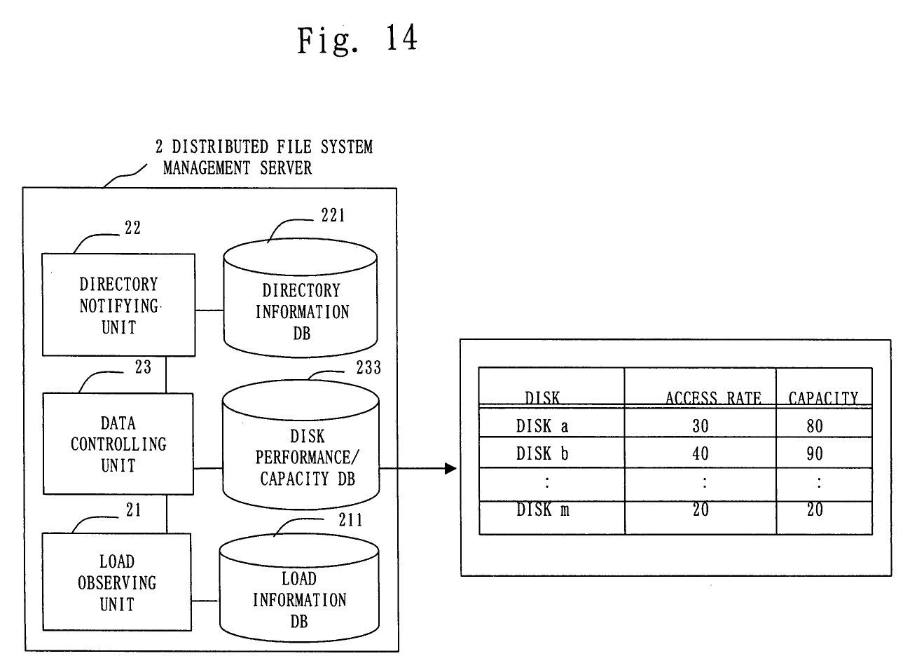

FIG. 14 shows the distributed file system management server 2 in connection with this embodiment. In the figure, the data controlling unit 23 includes a disk performance/capacity database 233. The disk performance/capacity database 233 stores the performance/capacity information showing the performance of the disks (in the figure, an access rate) and the spare capacity of the disks.

The operation will be explained in the following. The operation of the data controlling unit 23 is the same as one shown in the flowchart of FIG. 10 except for the step s20. The data controlling unit periodically observes the load information database 211 (s17), and when the load of arbitrary data exceeds a certain level (s18), the data controlling unit divides the data by the procedures shown in the second or the third embodiment (s19). Then, by referring to the disk performance/capacity database, a destination disk is determined (s20). The divided data is moved to the determined disk (s21), and by reflecting this data migration, the directory information of the directory information database 221 is updated (s22).

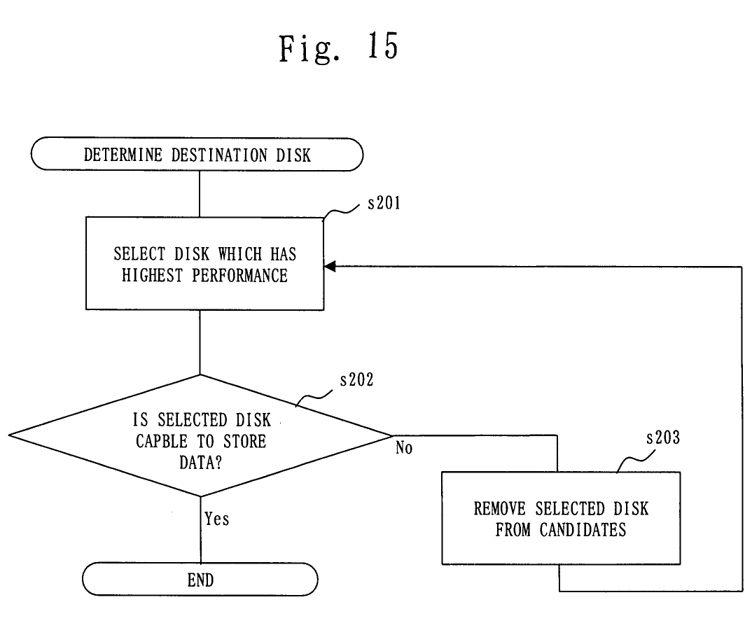

Here, a detailed process of determination of the destination disk at the step s20 will be explained by referring to FIG. 15. First, a disk which has the highest disk performance (an access rate, for example) is selected (s201), and it is checked if the selected disk has enough space to store the data to be allocated (s202). If the selected disk has enough space, this disk is determined as the destination disk of the data. If not, the disk selected at s201 is removed from candidates (s203), and the process returns to s201 again. In this way, the disk which is capable to store the target data for migration and has the highest performance is selected.

By the above operation, it is possible to allocate the data to the disk which is capable to store the target data for migration and has the highest performance and thus improve the availability.

Embodiment 10.

In the above fifth embodiment, the disk is determined based on the service level of the data. Next, another embodiment will be explained in which the reliability is improved by creating copies of the data and distributing them to plural disks based on the service level of the data.

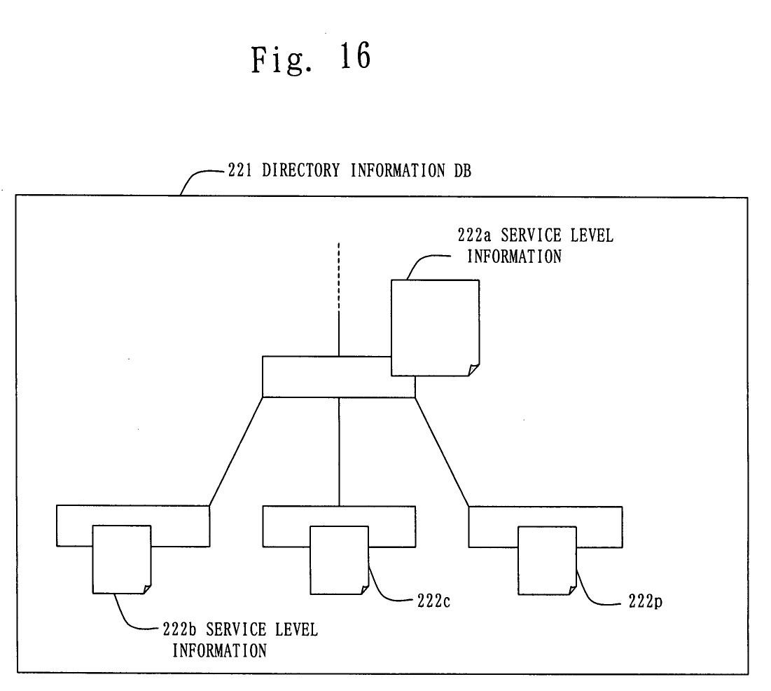

FIG. 16 shows an example of the directory information database in such a case. A data part which requires the reliability among the directory tree is made redundant.

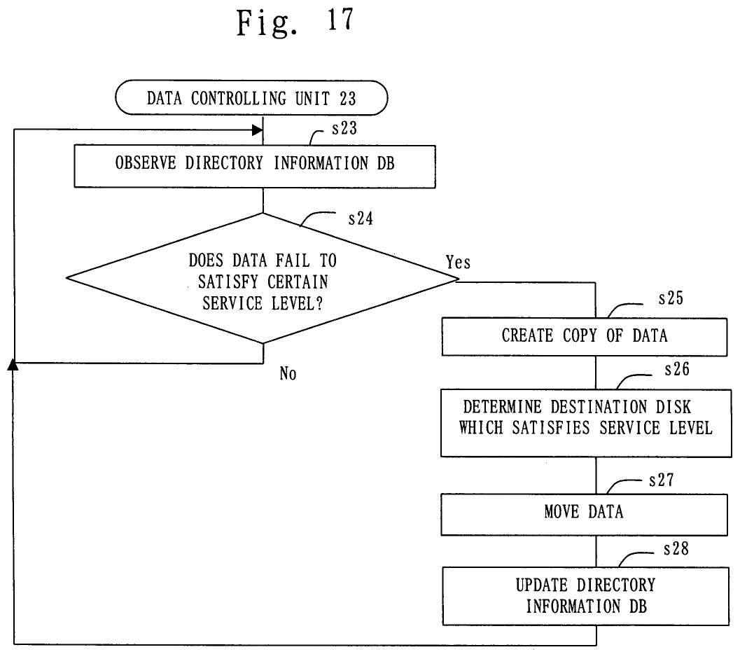

The operation will be explained in the following. FIG. 17 is a flowchart related to the data controlling unit 23 of the distributed file system management server 2 in connection with this embodiment. The data controlling unit periodically observes the service level information of the directory information database 221 (s23), and when arbitrary data does not meet a certain service level (s24), the data controlling unit creates a copy of the data (s25). Then, a disk whose service level exceeds the certain service level for the copy data is determined (s26), the copy data is moved to the determined disk (s27), and by reflecting this data migration the directory information of the directory information database 221 is updated (s28).

By the above operation, it is possible to make the data which does not meet a certain service level redundant and thus improve the reliability.

Embodiment 11.

The above tenth embodiment allocates same data to plural disks by making data redundant with creating copies of the data. Next, another embodiment will be explained in which the availability is improved by notifying the directory information according to the service level of the data for an access request from the client.

The operation will be explained in the following. In the present embodiment, it is assumed that since the data which a client wants to access has been moved from its original disk to another disk, the client cannot access the data by referring to cache of the client's directory information, and the client needs to make an inquiry for the directory information to the distributed file system management server 2. It is also assumed that in this embodiment, a copy of the data which the client wants to access has been created and the copy data is allocated to one of the disks. Therefore, upon receiving an inquiry for the directory information from the client, the distributed file system management server 2 selects one out of plural disks and notifies the client of the directory information including the selected disk.

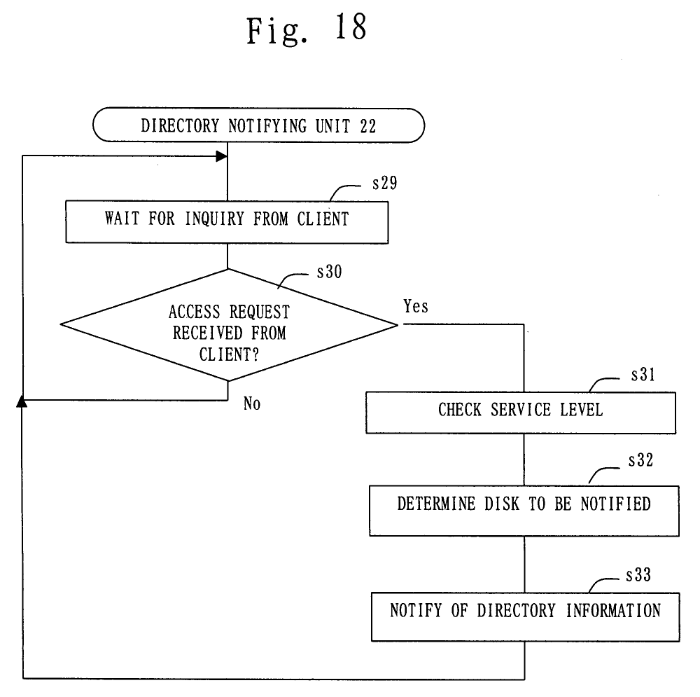

FIG. 18 shows a flowchart in connection with the directory notifying unit 22 of the distributed file system management server 2 according to the present embodiment. First, the directory notifying unit waits for an access request (an inquiry for directory information) from a client (s29). Here, the access request from the client is assumed to include notification of service level of the data requested by the client. Next, when the access request is received from the client (s30), the service level of the data requested by the client is checked (s31), and an optimal disk for notifying the client is determined (s32). Concretely, among plural identical pieces of data including the copy data, data which matches the service level requested by the client is selected, and the disk storing the selected data is determined as a disk to be notified to the client. Then, the directory information including the determined disk is notified to the client (s33).

By the above operation, it is possible to notify the directory information optimal to the client and thus improve the availability.

Embodiment 12.

The above tenth embodiment makes the data redundant using the service level of the data. Next, another embodiment will be explained in which the availability is improved by selecting data which is made redundant according to the service level of the client.

Namely, in the tenth embodiment, the data is copied so as to comply with the service level of the data (for example, the data has to be duplicated in order to improve the reliability, etc.), however, by only doing so, there is still possibility to locate one piece of the duplicated data at a location which is far on the network from a certain client or a location where the client cannot access. Therefore, the data controlling unit according to this embodiment allocates the data with considering the service level of the client (for example, it is necessary to locate data A in a location within metric=2 from a client “a”, etc.).

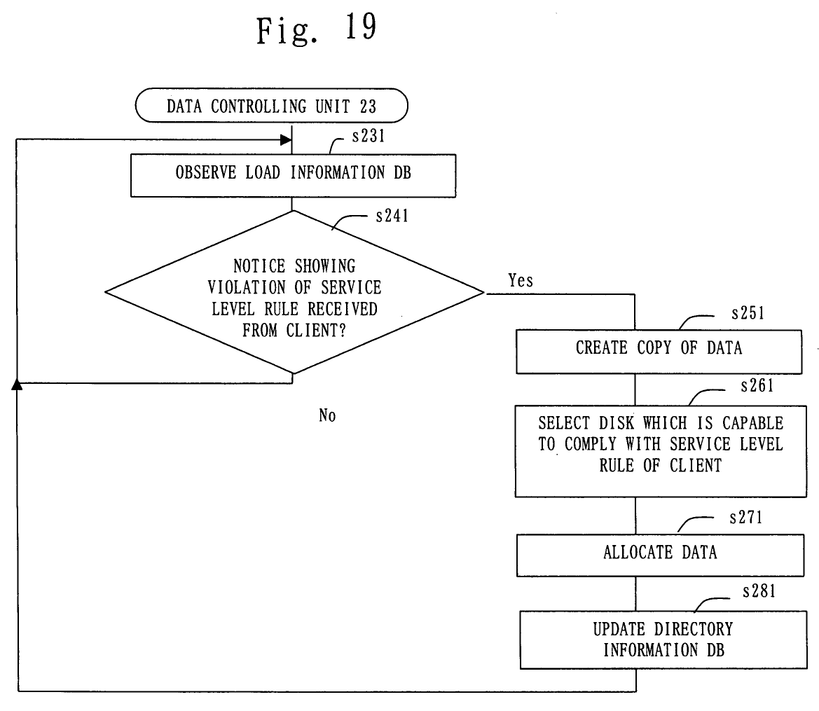

The operation will be explained in the following. FIG. 19 is a flowchart showing the operation of the data controlling unit 23 in connection with this embodiment. In the flowchart, when the data controlling unit 23 receives a notice showing violation of the service level rule from the client (s241), for example, when the notice showing the violation of the service level rule is received from the client because the distance from the client on the network of the data which has been divided and relocated by the data controlling unit exceeds a value specified by the service level, the data is copied (s251), and a disk is selected so as to comply with the service level of the client (s261). Then, the copy data is moved to the selected disk (s271), and the directory information of the directory information database is updated (s281) by reflecting this migration of the copy data.

By the above operation, it is possible to select the disk optimal to the client and thus improve the availability.

Embodiment 13.

In the eleventh embodiment, the directory information is notified according to the service level of the data for an access request from the client. Next, another embodiment will be explained in which the availability is improved by notifying the directory information according to the service level of the client.

The operation will be explained in the following. In the flowchart of FIG. 18 according to the eleventh embodiment, the disk to be notified is selected according to the service level of the data (s32), and the directory information is notified to the client (s33). In the present embodiment, as discussed in the twelfth embodiment, when the notice showing the violation of the service level rule is received from the client, the service level of the client is checked, the data is made redundant by creating copy data, and a disk which satisfies the service level requested by the client is determined among the disks including redundant data. Then, the directory information for the determined disk is notified to the client.

By the above operation, it is possible to notify the directory information optimal to the client and thus improve the availability.

Embodiment 14.

The above sixth embodiment carries out the migration and division of data based on the performance of the disk. Next, another embodiment will be explained in which the reliability is secured by automatically making the data redundant in case of data migration which accompanies reduction of the reliability of disk.

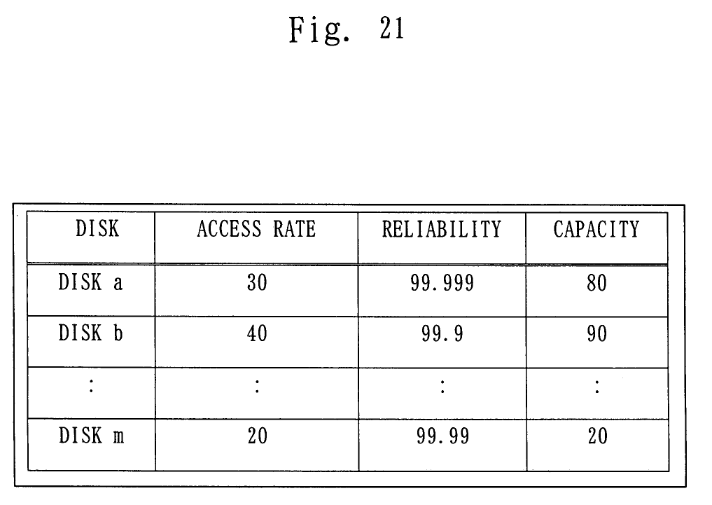

In the present embodiment, the disk performance/capacity database 233 stores disk performance/capacity information shown in FIG. 21. In this embodiment, the disk performance/capacity information indicates the reliability of disk as well as the performance (an access rate in FIG. 21) and the spare capacity of disk.

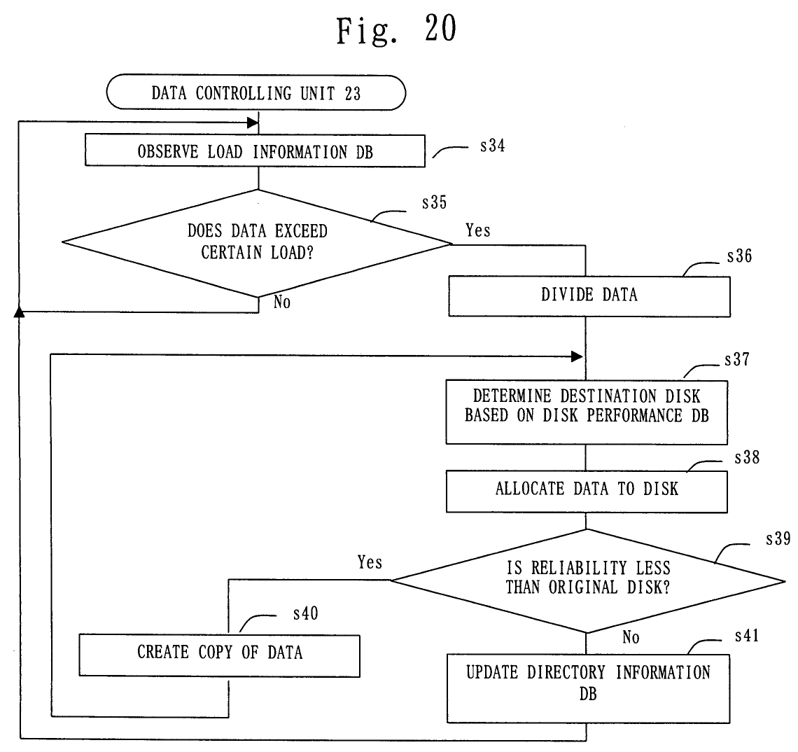

The operation will be explained in the following. FIG. 20 is a flowchart related to the data controlling unit 23 of the distributed file system management server 2 in connection with this embodiment. The data controlling unit periodically observes the load information database 211 (s34), and when a load of arbitrary data exceeds a certain level (s35), the data controlling unit divides the data by the procedures shown in the second or third embodiment (s36). Then, a destination disk is determined based on the disk performance database (s37) and the data is moved (s38). At this time, when the reliability becomes lower than the original disk (s39), that is, when the reliability of the destination disk of the divided data is lower than the disk which has originally stored the data before the division, a copy of the divided data is created (s40) and the copy data is allocated to another disk (s37, s38). Further, when the reliability of the destination disk of the copy data is lower than the original disk (the disk storing the divided data of the original of copy data), a further copy is created in the same manner and moved to another disk. On the other hand, when the reliability of the destination disk is not lower than the original disk at the step s39, the directory information database is updated (s41).

By the above operation, it is possible to distribute the load with securing the reliability of data.

Embodiment 15.

In the above fourteenth embodiment, the data is automatically made redundant in order to prevent the reduction of the reliability of disk. Next, another embodiment will be explained in which the reliability is secured by automatically removing the redundancy of data in case of the data migration which accompanies the improvement of reliability of disk.

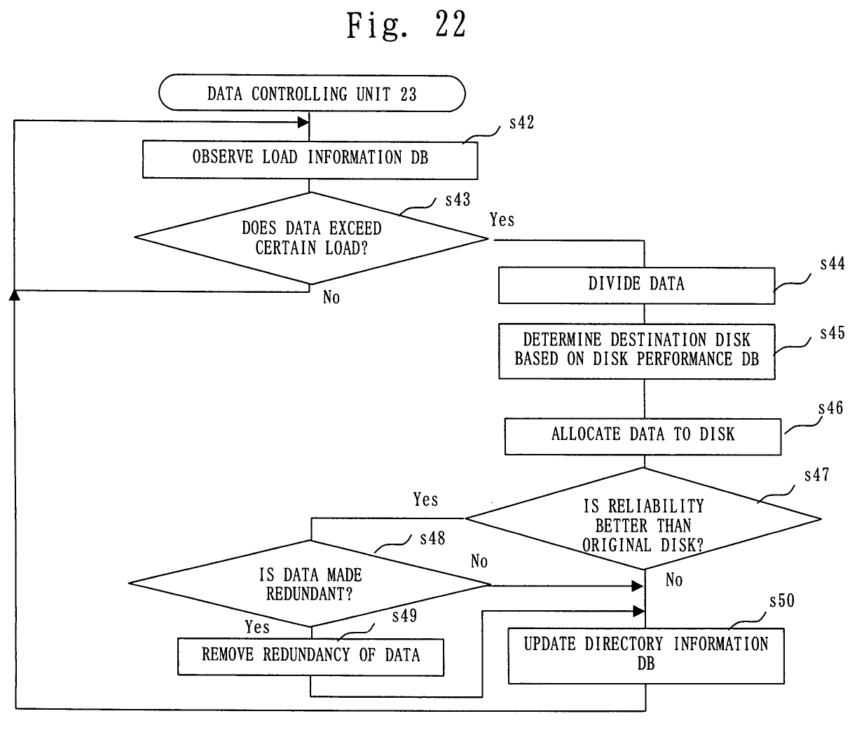

The operation will be explained in the following. FIG. 22 is a flowchart related to the data controlling unit 23 of the distributed file system management server 2 in connection with this embodiment. The data controlling unit periodically observes the load information database 211 (s42), and when a load of arbitrary data exceeds a certain level (s43), the data controlling unit divides the data by the procedure shown in the second or third embodiment (s44). Then, a disk to allocate the data is determined according to the disk performance database (s45), and the data is allocated (s46). At this time, when the reliability is higher than the original disk (s47), namely, when the reliability of disk where the divided data is moved is higher than the reliability of disk which has stored the data before the division, and also when the copy data of divided data is stored in another disk (s48), the redundancy of the data is removed (the copy data of another disk is deleted) (s49). When the reliability is not higher than the original disk, the directory information database is updated (s50).

By the above operation, it is possible to distribute the load with securing the reliability of data.

Embodiment 16.

In the foregoing embodiments, one distributed file system management server manages the load information or the directory information. Next, another embodiment will be explained in which the reliability is improved by arranging plural distributed file system management servers.

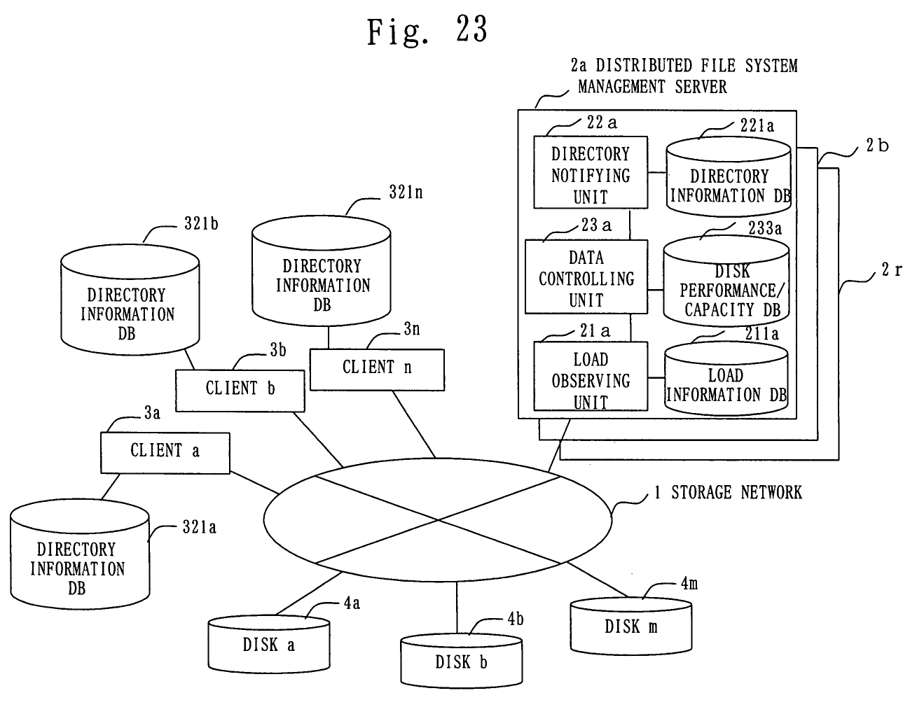

FIG. 23 is a configuration example showing the distributed file system according to the sixteenth embodiment. In the figure, 2a through 2r show a group of distributed file system management servers, which are connected to the storage network 1. Here, it is assumed that each of the distributed file system management servers has the same internal configuration.

The operation will be explained in the following. Upon updating the load information database 211, the directory information database 221, and the disk performance/capacity database 233, the load observing unit 21, the directory notifying unit 22, and the data controlling unit 23 also update databases of the other distributed file system management servers. During the updating operation, each database is locked, and the databases cannot be updated by the directory notifying unit, the data controlling unit, and the load observing unit of other management servers. Clients 3a through 3n make an inquiry to the group of distributed file system management servers and access the disk based on the directory information which is responded first.

By the above operation, it is possible to arrange plural distributed file system management servers and thus improve the reliability and performance.

Embodiment 17.

In the above sixteenth embodiment, each of the distributed file system management servers has the load information database 211, the directory information database 221, and the disk performance/capacity database 233. Next, another embodiment will be explained in which the performance is improved by arranging each database in the disks on a storage network.

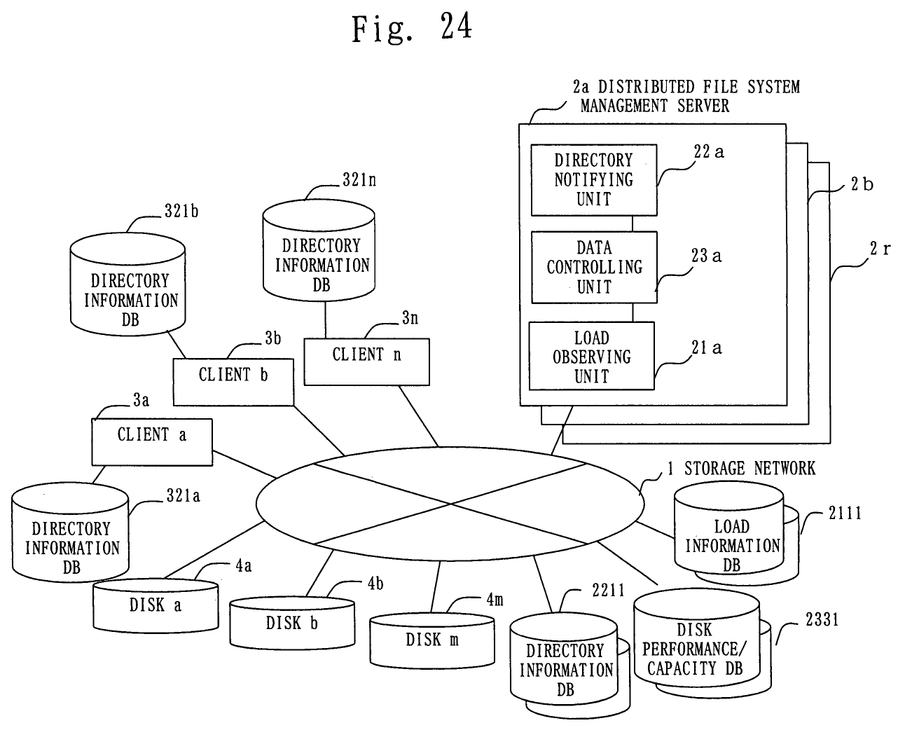

FIG. 24 shows a configuration example of the distributed file system according to the seventeenth embodiment. In the figure, 2111 shows a load information database, 2211 shows a directory information database, 2331 shows a disk performance/capacity database, each of which is connected to the storage network 1. Namely, each distributed file system management server does not include the load information database, the directory information database, and the disk performance/capacity database internally, but shares the load information database 2111, the directory information database 2211, and the disk performance/capacity database 2331 arranged on the storage network which is common network. Here, it is assumed that each of the distributed file system management servers has the same internal configuration.

The operation will be explained in the following. When the update becomes necessary, the load observing unit 21, the directory notifying unit 22, and the data controlling unit 23 of each distributed file system management server 2 updates the load information database 2111, the directory information database 2211, and the disk performance/capacity database 2331 connected to the storage network 1. During the update operation, each database is locked, and the directory notifying unit, the controlling unit, and the load observing unit of other management servers cannot update the database. The clients 3a through 3n make an inquiry to the group of distributed file system management servers, and the clients 3a through 3n access the disk based on the directory information which is responded first.

By the above operation, coordination of the databases becomes unnecessary among the distributed file system management servers, which improves the performance.

Embodiment 18.

In the foregoing embodiments, the data controlling unit manages all the directory information. Next, another embodiment will be explained in which the data controlling unit of each of the distributed file system management servers mutually compensates the directory information to manage it.

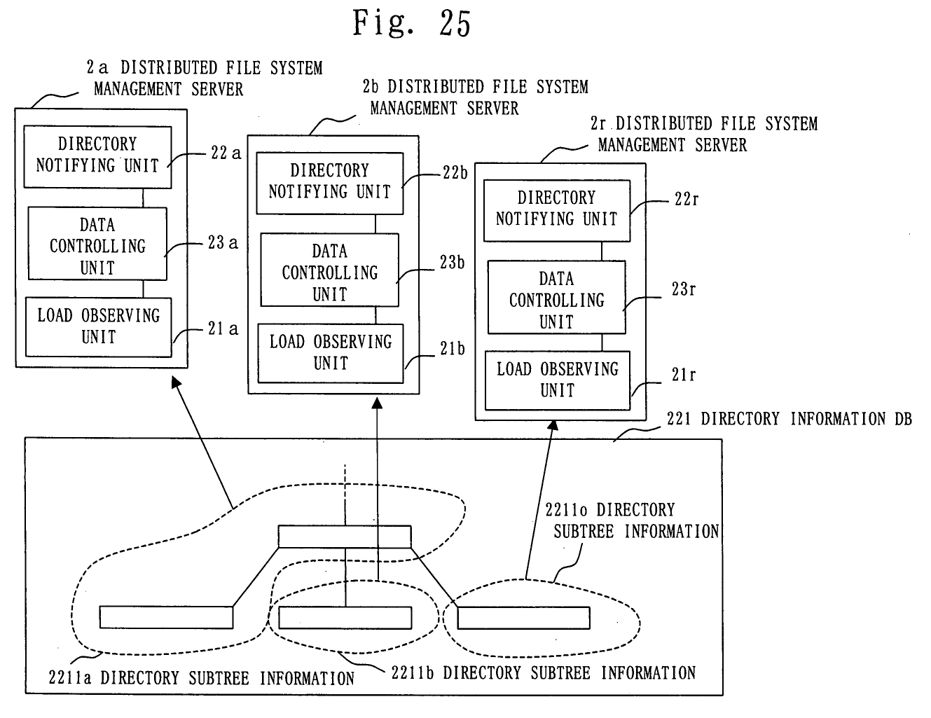

FIG. 25 is a diagram showing the distributed file system management servers and the directory information database according to the eighteenth embodiment. In the figure, 2a through 2r show distributed file system management servers, 221 shows a directory information database, 2211a through 2211o show directory subtree information managed by each data controlling unit.

The operation will be explained in the following. Upon receiving an inquiry for the directory information from the client, the distributed file system management server searches the directory information database. Here, if the data to be notified is not included in the directory subtree information which the server manages, the inquiry from the client is transferred to another distributed file system management server which manages the directory information of the data of the target. Then, the distributed file system management server which receives the transferred inquiry from the client transmits the client the directory information based on the directory subtree information which the server manages.

By the above operation, it is possible to distribute the inquiry for the directory information from the client and thus improve the availability.

Embodiment 19.

In the foregoing embodiments, each of the distributed file system management servers manages the directory information database which is a master. Next, another embodiment will be explained in which the management of the directory subtree information is transferred to the client whose access frequency is high.

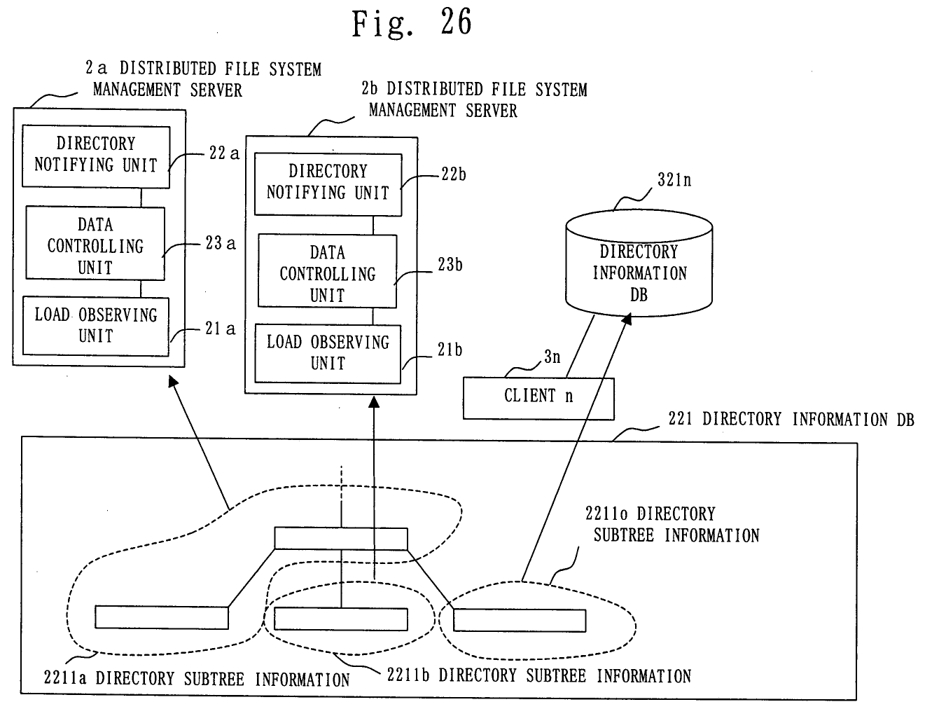

FIG. 26 is a diagram showing the distributed file system management server and the directory information database according to the nineteenth embodiment. In the figure, 2a through 2r show distributed file system management servers, 3n shows a client, 321n shows a directory information database cached by the client, 221 shows a directory information database, and 2211a through 2211o show directory subtree information managed by each of the data controlling units and the client.

The operation will be explained in the following. When an access frequency of certain directory subtree information is high, the distributed file system management server having such directory subtree information moves the directory subtree information to the directory information database of the client.

In case of accessing data, first the client searches the directory subtree in the directory information database of the client. When the directory subtree information managed by the client does not include information of the corresponding data, the client sends an inquiry for the directory information to the distributed file system management server which manages the directory information of the target, updates the cache of the directory information database, and access the data according to the updated directory information.

By the above operation, it is possible to reduce the load of inquiry for the directory information and thus improve the availability.

Embodiment 20.

In the above nineteenth embodiment, the distributed file system management server transfers the management of the directory subtree information to the client. Next, another embodiment will be explained in which the directory subtree information is returned to the distributed file system management server when the access frequency of the directory subtree information held by the client becomes low.

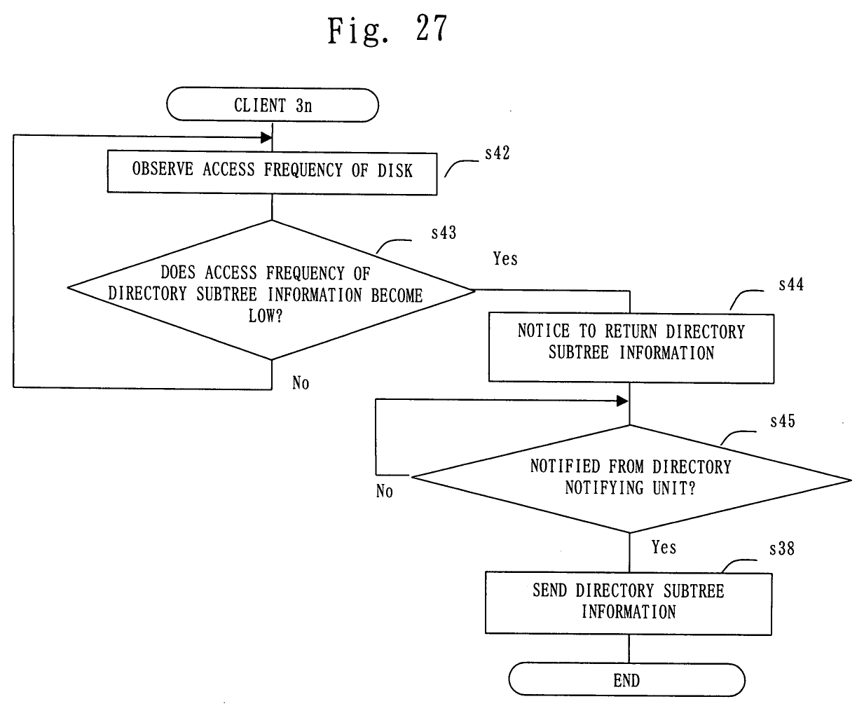

The operation will be explained in the following. FIG. 27 is a flowchart related to the data controlling unit 23 of the distributed file system management server 2 in connection with this embodiment. The client observes the access frequency of the directory subtree information held by the client (s42), and when the access frequency becomes low (s43), the client informs the distributed file system management server that the directory subtree information should be returned (s44). When a directory notifying unit holds directory subtree information linked to the directory subtree information transferred to the client, the directory notifying unit sends the client a return request of the directory subtree information. The client who receives the return request transmits the directory subtree information to the distributed file system management server which has sent the return request. Accordingly, the distributed file system management server manages again the directory subtree information which has been managed by the client.

By the above operation, it is possible to flexibly move the directory subtree information and thus improve the availability.

Embodiment 21.

In the foregoing embodiments, the storage network is used for sending/receiving information each of between the clients and the distributed file system management server, the clients and the disks, and the distributed file system management server and the disks and also for observing the loads of the disks from the distributed file system management server. Next, another embodiment will be explained in which another network is used between the clients and the distributed file system management server.

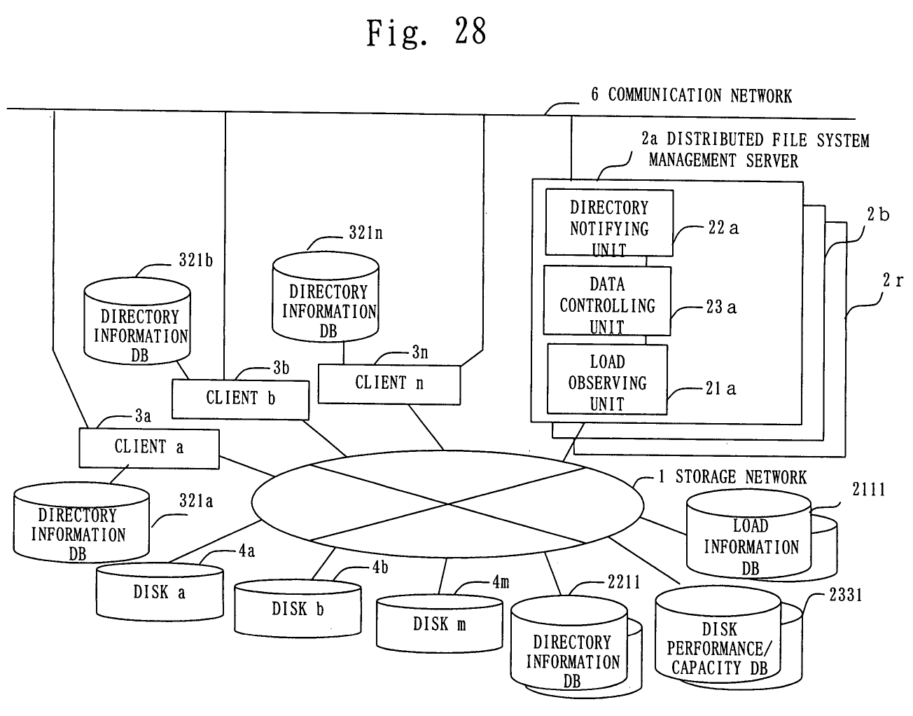

FIG. 28 shows a configuration example of a distributed file system according to the twenty-first embodiment, and 6 shows a communication network between the clients and the distributed file system management server.

The operation will be explained in the following. The clients and the distributed file system management server do not use the storage network but use the communication network 6 for making an inquiry from the clients to the distributed file system management server, sending/receiving the directory subtree information, and further for notifying the clients of the directory information from the distributed file system management server.

By the above operation, it is possible to distribute the load of network and thus improve the performance.

Embodiment 22.

In the twenty-first embodiment, the storage network is used for sending/receiving information each of between the clients and the disks, the distributed file system management server and the disks and also for observing the loads of the disks from the distributed file system management server. Next, another embodiment will be explained in which another network is used for observing the loads of the disks from the distributed file system management server.

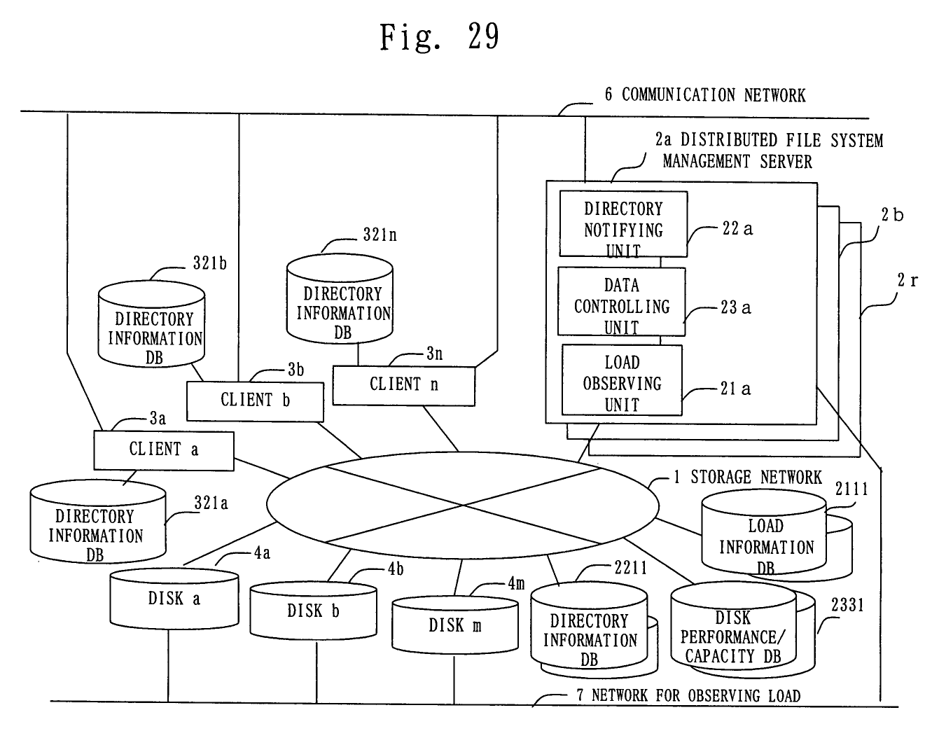

FIG. 29 shows a configuration example of the distributed file system according to the twenty-second embodiment, and 7 shows a network for observing the load of the disk from the distributed file system management server.

The operation will be explained in the following. The distributed file system management server does not use the storage network but uses the network 7 for the load observation when the distributed file system management server observes the loads of the disks.

By the above operation, it is possible to distribute the load of the network and thus improve the performance.

Hereinafter, the features of the distributed file system management servers which have been explained in the above first through twenty-second embodiments will be described.

The distributed file system explained in the first embodiment includes a storage network, a distributed file system management server, a group of clients, and a group of disks. The distributed file system management server observes the load of the storage network, moves the data on the disk according to the load, updates the directory information, and notifies the client who requests to access arbitrary data of the updated directory information corresponding at least to the arbitrary data.

In the distributed file system explained in the second embodiment, when a certain load is concentrated on arbitrary data, the distributed file system management server divides the arbitrary data into plural pieces of data, and distributes them to arbitrary plural disks.

In the distributed file system explained in the third embodiment, the distributed file system management server changes the number of divided data according to the load to access data.

In the distributed file system explained in the forth embodiment, when the load of consecutive plural pieces of data is under a predetermined level, the distributed file system management server unites the consecutive plural pieces of data to store in an arbitrary disk.

In the distributed file system explained in the fifth embodiment, a service level of each data is recorded in the directory information of the distributed file system management server, and the data is moved, divided, and united based on the data service level information.

In the distributed file system explained in the sixth embodiment, the performance of each disk is recorded in the distributed file system management server, and the data is moved, divided, and united based on the disk performance information.

In the distributed file system explained in the seventh embodiment, the capacity of each disk is recorded in the distributed file system management server, and the data is moved, divided, and united based on the disk capacity information.

In the distributed file system explained in the eighth embodiment, the service level of each client is recorded in the directory information of the distributed file system management server, and the data is moved, divided, and united based on the client service level information.

In the distributed file system explained in the ninth embodiment, the service level of each data and each client, and the performance of disk are recorded in the directory information of the distributed file system management server, and the data is moved, divided, and united based on the information.

In the distributed file system explained in the tenth embodiment, the distributed file system management server makes the data redundant according to the service level of each data.

In the distributed file system explained in the eleventh embodiment, the distributed file system management server notifies the directory information according to the service level of each data in response to an access request from the client.

In the distributed file system explained in the twelfth embodiment, the distributed file system management server makes the data redundant according to the service level of each client.

In the distributed file system explained in the thirteenth embodiment, the distributed file system management server notifies the directory information in response to an access request from the client according to the service level of the client.

In the distributed file system explained in the fourteenth embodiment, the distributed file system management server automatically makes the data redundant according to the performance of the disk in case of the data migration which accompanies the reduction of reliability.

In the distributed file system explained in the fifteenth embodiment, the distributed file system management server automatically removes the redundancy of the data according to the performance of the disk in case of the data migration which accompanies the improvement of reliability.

The distributed file system explained in the sixteenth embodiment includes plural distributed file system management servers, and when any one of the distributed file system management servers updates the directory information, the other distributed file system management servers carry out similar update operation.

In the distributed file system explained in the seventeenth embodiment, the databases of the distributed file system management server are placed on a storage network to be shared among the distributed file system management servers, which improves the access performance to the databases.

In the distributed file system explained in the eighteenth embodiment, by providing plural distributed file system management servers for subtrees of directory information, it is possible to distribute inquiries of the directory information from clients and thus improve the availability.

In the distributed file system explained in the nineteenth embodiment, the distributed file system management server transfers the directory subtree information of arbitrary data to the client whose access frequency to the arbitrary data is high.

In the distributed file system explained in the twentieth embodiment, when the access frequency of the transferred directory subtree information becomes low, the client returns the directory subtree information to the distributed file system management server.

In the distributed file system explained in the twenty-first embodiment, the storage network which is the network for disk access, and the network between the distributed file system management server and the client, are used.

In the distributed file system explained in the twenty-second embodiment, the storage network which is the network for disk access, the network for load observation, and the network between the distributed file system management server and the client, are used.

Having thus described several particular embodiments of the present invention, various alterations, modifications, and improvements will readily occur to those skilled in the art. Such alterations, modifications, and improvements are intended to be part of this disclosure, and are intended to be within the spirit and scope of the present invention. Accordingly, the foregoing description is by way of example only, and is not intended to be limiting. The present invention is limited only as defined in the following claims and the equivalents thereto.

1. A data management apparatus connected to a plurality of data storage devices and a plurality of data obtainment devices being capable to obtain data by accessing any one of the data storage devices, the data management apparatus comprising:
a directory information database storing directory information showing which data is stored in which of the data storage devices;
a load observing unit observing load status of the plurality of data storage devices;
a data controlling unit analyzing an observation result by the load observing unit, when the load status of a specific data storage device matches a predetermined condition, moving at least a part of data stored in the specific data storage device to any one of the data storage devices, and updating the directory information by reflecting the data migration; and
a directory notifying unit, when an inquiry of directory information related to the data which has been moved by the data controlling unit is received from a specific data obtainment device, sending at least the directory information related to the moved data among the directory information after updating to the specific data obtainment device.

2. The data management apparatus of claim 1, wherein
the data management apparatus is connected to a plurality of data obtainment devices having a cache of directory information; and
the directory notifying unit, when an inquiry of directory information related to the data which has been moved by the data controlling unit is received from a specific data obtainment device, sends at least the directory information related to the moved data among the directory information after updating to the specific data obtainment device so as to update the cache of directory information held by the specific data obtainment device.

3. The data management apparatus of claim 1,
wherein the data controlling unit analyzes the observation result of the load observing unit, when a load of a specific data storage device exceeds a predetermined level, moves at least a part of data stored in the specific storage device to any one of the data storage devices, and updates the directory information by reflecting the data migration.

4. The data management apparatus of claim 1,
wherein the load observing unit observes the load status of each data stored in each of the data storage devices, and
wherein the data controlling unit analyzes the observation result of the load observing unit, when the load of the specific data exceeds a predetermined level, divides the specific data into an arbitrary number of pieces, moves at least a part of divided data which has been divided from the specific data to any one of the data storage devices, and updates the directory information by reflecting the data migration.

5. The data management apparatus of claim 1,
wherein the load observing unit observes the load status of each data area of the data stored in each of the data storage devices, and
wherein the data controlling unit analyzes the observation result of the load observing unit, when the load of a specific data area exceeds a predetermined level, divides the specific data area into an arbitrary number of pieces, moves at least a part of divided data divided from the specific data area to any one of the data storage devices, and updates the directory information by reflecting the data migration.

6. The data management apparatus of claim 1,
wherein the load observing unit observes the load status of each data stored in each of the data storage devices, and
wherein the data controlling unit analyzes the observation result of the load observing unit, when the load of a plurality pieces of mutually consecutive data is under a predetermined level, unites the plurality pieces of mutually consecutive data into united data, moves the united data to any one of the data storage devices, and updates the directory information by reflecting the data migration.

7. The data management apparatus of claim 4,
wherein the directory information database stores service level information for each data showing service level of each of the data stored in each of the data storage devices, and
wherein the data controlling unit, when the load of a plurality pieces of data exceeds a predetermined level, divides each of the plurality pieces of data into an arbitrary number of pieces, by referring to the service level information for each data stored in the directory information database, determines an order to move the plurality pieces of data based on the service level of each data, moves divided data of each of the plurality pieces of data according to the order determined, and updates the directory information by reflecting each data migration.

8. The data management apparatus of claim 1,
wherein the data controlling unit selects a data storage device for a destination of data migration from the plurality of data storage devices based on characteristics of each of the plurality of data storage devices and moves data to the data storage device selected.

9. The data management apparatus of claim 1,
wherein the data controlling unit selects a data storage device for a destination of data migration from the plurality of data storage devices based on spare capacity of each of the plurality of data storage devices and moves data to the data storage device selected.

10. The data management apparatus of claim 1,
wherein the directory information database stores service level information for each obtainment device showing service level set for each of the plurality of data obtainment devices, and
wherein the data controlling unit refers to the service level information for each obtainment device stored in the directory information database, based on the service level set for a specific data obtainment device, selects a data storage device for a destination of data migration from the plurality of data storage devices, and moves data to the data storage device selected.

11. The data management apparatus of claim 1,
wherein the data controlling unit, selects a data storage device for a destination of the data migration from the plurality of data storage devices based on characteristics and spare capacity of each of the plurality of data storage device, and moves data to the data storage device selected.

12. The data management apparatus of claim 1,
wherein the data controlling unit, when a service level of specific data is under a predetermined level, generates copy data of the specific data, moves the copy data to a data storage device in which a service level of the copy data generated exceeds the predetermined level, and updates the directory information by reflecting the data migration.

13. The data management apparatus of claim 1,
wherein the data controlling unit sometimes generates a plurality of pieces of copy data of specific data, and makes service levels of the plurality of pieces of copy data different by moving the plurality of pieces of copy data to different data storage devices, and
wherein the directory notifying unit, upon receiving an inquiry of the directory information related to original data of the copy data as well as a notice of the service level requested by a specific data obtainment device from the specific data obtainment device, selects one of the plurality of pieces of copy data which matches the service level requested by the specific data obtainment device, and sends at least directory information related to the one of the plurality of pieces of copy data selected to the specific data obtainment device.

14. The data management apparatus of claim 1,
wherein the data controlling unit, upon receiving a notice showing a service level of specific data does not match a service level required by a specific data obtainment device from the specific data obtainment device, generates copy data of the specific data, moves the copy data generated to a data storage device in which the service level requested by the specific data obtainment device can be obtained, and updates the directory information by reflecting the data migration.

15. The data management apparatus of claim 1,
wherein the data controlling unit sometimes generates a plurality of pieces of copy data of specific data, and makes service levels of the plurality of pieces of copy data different by moving the plurality of pieces of copy data to different data storage devices, and
wherein the directory notifying unit, after the data controlling unit performs data migration of the plurality of pieces of copy data and updates the directory information, selects one of the plurality of pieces of copy data which matches a service level requested by a specific data obtainment device, and sends the directory information related to the one of the plurality of pieces of copy data to the specific data obtainment device.

16. The data management apparatus of claim 1,
wherein the load observing unit observes load status of each data stored in each of the plurality of data storage devices, and
wherein the data controlling unit analyzes an observation result, when a load of specific data exceeds a predetermined level, divides at least a part of the specific data into an arbitrary number of pieces, moves at least a part of divided data which has been divided from the specific data to any one of the plurality of data storage devices, as a result of the data migration of the divided data, when reliability of a data storage device which is a destination of the divided data migration is under reliability of a data storage device which has originally stored the specific data, generates copy data of the divided data moved, and moves the copy data generated to another one of the plurality of data storage devices.

17. The data management apparatus of claim 16,
wherein the data controlling unit, as a result of the data migration of the copy data, when reliability of a data storage device which is a destination of the copy data migration is under reliability of a data storage device which has originally stored the divided data, generates new copy data of the copy data moved, and moves the new copy data generated to another one of the plurality of data storage devices.

18. The data management apparatus of claim 1,
wherein the load observing unit observes load status of each data stored in each of the plurality of data storage devices, and
wherein the data controlling unit analyzes an observation result, when a load of specific data exceeds a predetermined level, divides at least a part of the specific data into an arbitrary number of pieces, moves at least a part of divided data which has been divided from the specific data to any one of the plurality of data storage devices, as a result of data migration of the divided data, when reliability of a data storage device which is a destination of the divided data migration exceeds reliability of a data storage device which has originally stored the specific data and also when copy data of the divided data moved is stored in another one of the plurality of data storage devices, deletes the copy data stored in the another one of the plurality of data storage devices.

19. The data management apparatus of claim 1,
wherein the data management apparatus is capable to communicate with another data management apparatus having directory information, and
wherein the data controlling unit, when updating the directory information of the data management apparatus, updates the directory information of the another data management apparatus.

20. The data management apparatus of claim 19,
wherein the load observing unit notifies the another data management apparatus of the observation result of the load status of each of the plurality of data storage devices.

21. The data management apparatus of claim 1,
wherein the data management apparatus sets a common directory information database which can be shared with another data management apparatus on a common network to be shared with the another data management apparatus, and
wherein the data controlling unit, when performing data migration of any data, updates common directory information stored in the common directory information database.

22. The data management apparatus of claim 21, wherein
the data management apparatus manages specific directory subtree information among directory subtree information included in the common directory information database, and
the data management apparatus, upon receiving an inquiry for the directory information related to specific data from a specific data obtainment device, when the specific data for which the inquiry has been made is not included in the specific directory subtree information which is managed by the data management apparatus itself, transfers the inquiry from the specific data obtainment device to another one of the data management apparatus, makes the another one of the data management apparatus send the directory information related to the specific data for which the inquiry has been made to the specific data obtainment device.

23. The data management apparatus of claim 22,
wherein the data management apparatus sends at least a part of the directory subtree information which is managed by the data management apparatus itself to any one of the plurality of data obtainment devices and makes the data obtainment device to which at least a part of the directory subtree information is sent manage at least the part of the directory subtree information which is managed by the data management apparatus itself.

24. The data management apparatus of claim 23,
wherein the data management apparatus, when at least a part of the directory subtree information which is supposed to be managed by the data management apparatus is managed by one of the plurality of data obtainment devices, and when the directory subtree information managed by the one of the plurality of data obtainment devices needs to be returned, receives the directory subtree information managed by the one of the plurality of data obtainment devices from the one of the plurality of data obtainment devices, and manages again the directory subtree information received.

25. The data management apparatus of claim 1, wherein
the data management apparatus is connected to a storage network which connects the plurality of data storage devices and the plurality of data obtainment devices, and
the data management apparatus communicates with the plurality of data storage devices and the plurality of data obtainment devices via the storage network.

26. The data management apparatus of claim 1, wherein
the data management apparatus is connected to the plurality of data obtainment devices via other network besides a storage network which connects the plurality of data storage devices and the plurality of data obtainment devices, and
the data management apparatus communicates with the plurality of data obtainment devices via the other network.

27. The data management apparatus of claim 1, wherein
the data management apparatus is connected to the plurality of data storage devices via other network besides a storage network which connects the plurality of data storage devices and the plurality of data obtainment devices, and
the data management apparatus observes the load status of the plurality of data storage devices via the other network.
